(19) United States
(12) Patent Application Publication
(10) Pub. No.: US 2010/0282692 A1
(43) Pub. Date: Nov. 11, 2010

(54) PERCOLATION FILTER SYSTEM WITH A REPLACEABLE CARTRIDGE, A METHOD FOR DETERMINING THE DEPLETION OF A REPLACEABLE CARTRIDGE IN A FILTER SYSTEM AND A KIT INTEGRATING THIS METHOD

(76) Inventor: Olga Alexandrou, Nicosia (CY)

Correspondence Address: CASTELLANO PLLC, P.O. Box 1555, Great Falls, VA, 22066, US

(21) Appl. No.: 12/671,205

(22) PCT Filed: Jul. 31, 2007
(86) PCT No.: PCT/EP2007/006833

§ 371 Date: May 2, 2010

(51) Int. Cl. B01D 35/14; B01D 37/04; C02F 5/00

(52) U.S. Cl. 210/767; 210/85

(57) ABSTRACT

A percolation filter system with a replaceable cartridge comprising means for determining and/or displaying a parameter representative of the residual service life and/or level of depletion of the cartridge in order to inform the user of this parameter with a view to the replacement of the spent cartridge, characterised in that these determination means comprise means for correcting the determination and/or display of this parameter and means for setting the desired correction which may be set at will by the user.

The present invention relates to a percolation filter system with a replaceable cartridge, a method for determining the depletion of a replaceable cartridge in a filter system and a kit integrating this system and method.

When using jugs, kettles, teapots and like devices provided with a water filtering system of the so-called percolation type, with a replaceable cartridge, it is necessary to monitor and determine the service life of the filter cartridge and the parts subject to periodic maintenance.

Relatively sophisticated devices have been developed for this purpose and are adapted to count the cycles of use of the cartridge, the litres of water filtered and/or the time that has elapsed since its first use, in order to determine, as a function of these parameters, the degree of depletion and/or the residual service life of the cartridge.

It is also known, for instance from EP-1 484 097, that the quality of the water being treated may also have a substantial impact on the service life of the cartridge which may vary depending on the quality and the concentration of the pollutants which it is wished to remove by filtration.

These systems are relatively costly and complex, however, and their operation entails high electricity consumption.

The problem underlying the present invention is that of providing a percolation filter system structurally and functionally designed to overcome the drawbacks described with respect to the prior art.

This problem is addressed and resolved by the invention by means of a filter system according to the accompanying claims.

The characteristic features and advantages of the invention are set out in further detail in the following detailed description of a preferred, but not exclusive, embodiment thereof, shown by way of non-limiting example in the accompanying drawings, in which:

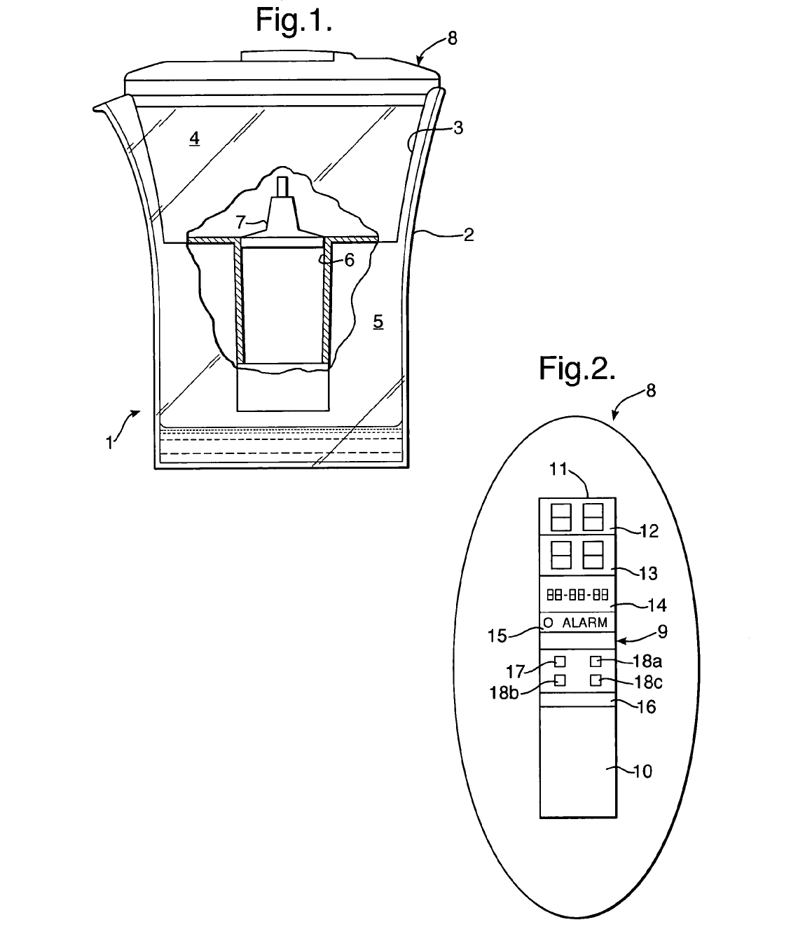

FIG. 1 is a diagrammatic view of a filter jug system of the invention;

FIG. 2 is a diagrammatic top view of a lid portion of the jug of FIG. 1;

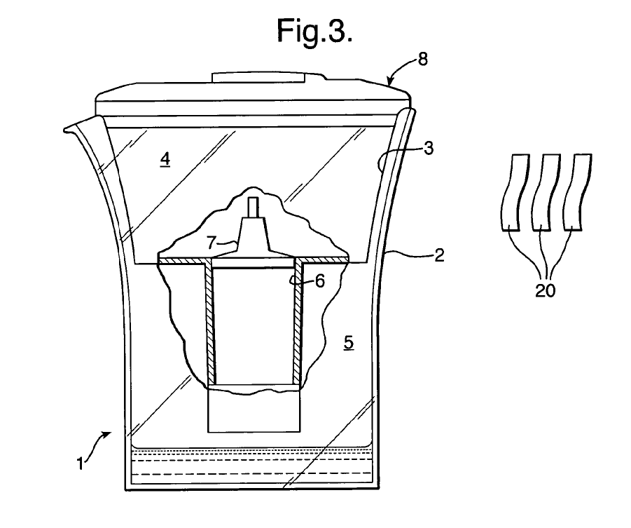

FIG. 3 is a diagrammatic view of a kit of the invention.

In FIG. 1, a filter jug according to the present invention is shown overall by 1. The jug 1 comprises, in a manner known per se, a container 2 within which a funnel-shaped hopper 3 is disposed, a tank 4 for collecting the water to be filtered being formed in the top portion of the hopper. A tank 5 adapted to collect the filtered water is in turn formed in the portion of the container 2 below the hopper 3. The two tanks 4, 5 communicate via a duct 6 in which a filter cartridge 7 of replaceable type is housed. The upper tank 4 is detachably closed by a lid 8 provided with means for determining and/or displaying a parameter representative of the residual service life and/or level of depletion of the cartridge 7 so that the user can be informed of this parameter with a view to replacing the spent cartridge. By way of example, these means 9 comprise a meter device 10 associated with a display 11 adapted to show, for instance, the number of filter cycles completed in a first window 12, the number of cycles left before the cartridge needs to be replaced in a second window 13, the date of first use of the inserted cartridge in a third window 14 and an alarm signal in a fourth window 15. The means 9 further comprise an operating circuit 16 in which the display management program is preloaded together with conventional metering devices. The operating circuit is connected to a system reset/start key 17 and a series of two or more keys 18a, b, c (three keys in the embodiment shown) of a control panel enabling manual selection of a desired correction of the metering of the depletion of the cartridge as a function of a physical-chemical parameter of the water being filtered.

This parameter is typically represented by the hardness of the water to be filtered as the actual life of the cartridge exchange resins depends in a non-negligible manner on this hardness as does the residual service life of the cartridge.

It has been observed that this parameter does not vary significantly over time if the jug is filled with water from the same water source, at least over the normal time span during which the service life of a filter cartridge is exhausted.

By way of example, each key may represent a class of hardness, for instance, high, medium or low hardness.

In the case of high hardness, for instance of the order of 40 degrees French, the cartridge should be considered to be spent 30 days after its first use and in any case after 200 filter cycles (equivalent to some 200 litres of filtered water).

In the case of medium hardness, for instance of the order of 20 degrees French, the cartridge should be considered to be spent 45 days after its first use and in any case after 250 filter cycles (equivalent to some 250 litres of filtered water).

In the case of low hardness, for instance of the order of 10 degrees French, the cartridge should be considered to be spent 60 days after its first use and in any case after 300 filter cycles (equivalent to some 300 litres of filtered water).

The software contained in the operating circuit 16 therefore offers three different metering options associated respectively with the three keys 18a, b, c in order to correct the determination and/or display of the parameter representative of the residual service life and/or level of depletion of the cartridge as a function of the water hardness setting set manually by the user.

The electronic control system may also be replaced by a mechanical corrector, adapted for instance to act on the transmission ratio between the metering mechanism and a mechanical indicator disc actuated stepwise in rotation after each cartridge filter cycle.

In order to determine the degree of hardness, reference may be made to the data supplied by the mains water provider in relation to the quality of the mains water supplied, or use may be made of appropriate known instruments used by hydraulic engineers and persons skilled in the art.

Alternatively, a kit may be supplied, with the jug and filter cartridges, of known cards 20 adapted to determine hardness, for instance using colorimetric evaluations. Cards of this type are commercially available, for instance from firms selling aquarium products.

As an alternative and/or in addition to hardness, other parameters representative of the physical-chemical state of the water to be treated may be detected and used for the desired correction, such as the concentrations of chlorine, nitrates and heavy metals, which may be detected by appropriate known reagents and detectors, or by the data supplied by the mains water provider and/or analysis laboratories and plant installers.

The invention thus resolves the above-mentioned problem with the obvious advantage of greater simplicity of use without a substantial reduction of the best possible use of the filter cartridges used. It may also be embodied in a simple manner using either electronic systems or mechanical or electro-mechanical systems.

1. A percolation filter system with a replaceable cartridge comprising means for determining and/or displaying a parameter representative of the residual service life and/or level of depletion of the cartridge in order to inform a user of said parameter with a view to the replacement of the spent cartridge, wherein said determination means comprise means for correcting the determination and/or display of said parameter and means for setting the desired correction which may be set at will by the user.

2. The filter system according to claim 1, wherein the setting means are adapted to enable at least two alternative settings of said correction.

3. The filter system according to claim 1, wherein the setting means are of the manually set type.

4. The filter system according to claim 3, wherein the setting means comprise a control panel connected to an operating circuit of the determination and/or display means in order to actuate said correction means as a function of the key of the control panel selected.

5. The filter system according to claim 1, wherein the correction means are of software type and such that, as a function of the correction selected by means of the setting means, a different determination of the parameter representative of the residual service life and/or level of depletion of the cartridge is generated.

6. The filter system according to claim 1, wherein the correction means are of mechanical or electro-mechanical type.

7. The filter system according to claim 1, wherein the means for setting the desired correction are correlated with the hardness of the water to be filtered.

8. The filter system according to claim 1, wherein the means for setting the desired correction are correlated with one or a plurality of parameters selected from the concentrations of chlorine, nitrates and heavy metals.

9. A method for determining the residual service life and/or level of depletion of the cartridge in order to inform the user of a parameter representative of said level of depletion with a view to the replacement of the spent cartridge, said method comprising correcting the determination and/or display of said parameter by setting of the desired correction by the user.

10. A kit including a filter system according to claim 1, and at least one separate means for determining the hardness of the water to be filtered.

11. The kit according to claim 10, wherein the means for determining the hardness of the water to be filtered comprise at least one card for determining hardness.

12. The kit according to claim 11, wherein the means for determining the hardness of the water to be filtered comprise at least one card for determining hardness using colorimetric evaluation.
